(19) United States
(12) Patent Application Publication
(10) Pub. No.: US 2014/0317624 A1
(43) Pub. Date: Oct. 23, 2014

(54) Method and device for implementing communications between virtual machines based on scheduling layer

(71) Applicant: Lingling Liang, Shenzhen (CN)

(72) Inventor: Lingling Liang, Shenzhen (CN)

(73) Assignee: ZTE CORPORATION, Shenzhen, Guangdong (CN)

(21) Appl. No.: 14/353,693

(22) PCT Filed: Jun. 27, 2012
(86) PCT No.: PCT/CN2012/077623

§ 371 Date: Apr. 23, 2014

(30) Foreign Application Priority Data
Apr. 16, 2012 (CN) 201210109101.3

(51) Int. Cl. G06F 9/455

(52) U.S. Cl. CPC G06F 9/45533
USPC 718/1

(57) ABSTRACT

The present disclosure provides a method for implementing communications between virtual machines, the method includes: receiving a first communication request sent by a source virtual machine, returning a first mark ID to the source virtual machine, and binding the first mark ID to a first callback function registered by the source virtual machine; receiving a second communication request sent by a target virtual machine, returning a second mark ID to the target virtual machine, and binding second mark ID to a second callback function registered by the target virtual machine; and forwarding communication information sent by the source virtual machine to the target virtual machine, and authorizing a CPU to the target virtual machine to process the communication information. The present disclosure also provides a corresponding device. In the method for implementing communications between virtual machines based on a scheduling layer, by using the scheduling layer, a source virtual machine can directly send communication information to a target virtual machine, thus improving communication speed between virtual machines to a large extent and saving memory resources.

### TECHNICAL FIELD

The present disclosure relates to the field of communication technology, and in particular to a method and a device for implementing communications between virtual machines based on a scheduling layer.

### BACKGROUND

A virtualized operating system can run multiple operating systems simultaneously on a single CPU. For a mobile phone and other mobile terminals, real-time is a very important index, when multiple virtual machines run simultaneously, rapid communication between multiple virtual machines is very important. In the prior art, the method for implementing communications between virtual machines mainly includes: sharing memory between two virtual machines, and then reading, by a CPU, contents of the shared memory to implement communications between the two virtual machines. However, the method usually requires virtual machines to allocate a specified memory, and when there is a need for communications between the virtual machines, a CPU is required to read contents of the shared memory. Thus, it results in poor real time capability of communications between two virtual machines, and a waste of CPU resources.

### SUMMARY

The present disclosure is mainly intended to provide a method and a device for implementing communications between virtual machines based on a scheduling layer. By using a scheduling layer, a source virtual machine in an upper layer can sent communication information to a target virtual machine directly through the scheduling layer, so as to achieve objectives such as improving communication speed between virtual machines and saving memory resources.

The present disclosure provides a method for implementing communications between virtual machines based on a scheduling layer, including:

a first communication request sent by a source virtual machine is received, a first mark ID for indicating that the first communication request is bound successfully, is returned to the source virtual machine, and the first mark ID is bound to a first callback function registered by the source virtual machine;

a second communication request sent by a target virtual machine using information provided by the source virtual machine is received, a second mark ID for indicating that the second communication request is bound successfully, is returned to the target virtual machine, and the second mark ID is bound to a second callback function registered by the target virtual machine; and

communication information sent by the source virtual machine is forwarded to the target virtual machine, and a CPU is authorized to the target virtual machine to process the communication information.

Preferably, before the first communication request sent by a source virtual machine is received, and the first mark ID for indicating that the first communication request is bound successfully, is returned to the source virtual machine, the method may further include:

states of the source virtual machine and the target virtual machine together with a communication information table for storing the communication information are initialized, and a source virtual machine ID number and a target virtual machine ID number are assigned to the source virtual machine and the target virtual machine, respectively.

Preferably, the target virtual machine using information provided by the source virtual machine, may include:

the target virtual machine using the source virtual machine ID number and the first mark ID provided by the source virtual machine.

Preferably, before the first mark ID for indicating that the first communication request is bound successfully, is returned to the source virtual machine, the method may further include:

the first communication request is stored in the communication information table.

Preferably, after the communication information sent by the source virtual machine is forwarded to the target virtual machine, and the CPU is authorized to the target virtual machine to process the communication information, the method may further include:

a cancelling communication request sent by the source virtual machine is received, and the communication information in the communication information table is deleted.

The present disclosure further provides a device for implementing communications between virtual machines based on a scheduling layer, including:

a first returning module, configured to receive a first communication request sent by a source virtual machine, return, a first mark ID for indicating that the first communication request is bound successfully, to the source virtual machine, and bind the first mark ID to a first callback function registered by the source virtual machine;

a second returning module, configured to receive a second communication request sent by a target virtual machine using information provided by the source virtual machine, return, a second mark ID for indicating that the second communication request is bound successfully, to the target virtual machine, and bind the second mark ID to a second callback function registered by the target virtual machine; and

a forwarding module, configured to forward communication information sent by the source virtual machine to the target virtual machine, and authorize a CPU to the target virtual machine to process the communication information.

Preferably, the device for implementing communications between virtual machines based on a scheduling layer may further include:

an initialization module, configured to initialize states of the source virtual machine and the target virtual machine together with a communication information table for storing the communication information, and assign a source virtual machine ID number and a target virtual machine ID number to the source virtual machine and the target virtual machine, respectively.

Preferably, the target virtual machine using information provided by the source virtual machine, may include: the source virtual machine ID number and the first mark ID.

Preferably, the device for implementing communications between virtual machines based on a scheduling layer may further include:

a storage module, configured to store the first communication request in the communication information table.

Preferably, the device for implementing communications between virtual machines based on a scheduling layer may further include:

a deleting module, configured to receive a cancelling communication request sent by the source virtual machine, and delete the communication information in the communication information table.

In the method for implementing communications between virtual machines based on a scheduling layer according to the present disclosure, firstly, the first communication request and the second communication request sent respectively by the source virtual machine and the target virtual machine are received, and the first mark ID and the second mark ID for indicating successful bindings are returned, so that the source virtual machine and the target virtual machine are bound to their respectively received mark IDs. Then, the communication information sent by the source virtual machine is forwarded to the target virtual machine, and the CPU is authorized to the target virtual machine to process the communication information. By means of the method to implement communications between the source virtual machine and the target virtual machine, the source virtual machine in an upper layer can sent directly communication information to the target virtual machine, thus improving communication speed between virtual machines and saving memory resources.

### BRIEF DESCRIPTION OF THE DRAWINGS

FIG. 1 shows a schematic flow chart of a method for implementing communications between virtual machines based on a scheduling layer according to an embodiment of the present disclosure;

FIG. 2 shows a schematic flow chart of a method for implementing communications between virtual machines based on a scheduling layer according to another embodiment of the present disclosure;

FIG. 3 shows a schematic flow chart of a method for implementing communications between virtual machines based on a scheduling layer according to yet another embodiment of the present disclosure;

FIG. 4 shows a schematic flow chart of a method for implementing communications between virtual machines based on a scheduling layer according to still another embodiment of the present disclosure;

FIG. 5 shows a schematic flow chart of a device for implementing communications between virtual machines based on a scheduling layer according to an embodiment of the present disclosure;

FIG. 6 shows a schematic flow chart of a device for implementing communications between virtual machines based on a scheduling layer according to another embodiment of the present disclosure;

FIG. 7 shows a schematic flow chart of a device for implementing communications between virtual machines based on a scheduling layer according to yet another embodiment of the present disclosure; and

FIG. 8 shows a schematic flow chart of a device for implementing communications between virtual machines based on a scheduling layer according to still another embodiment of the present disclosure.

### DETAILED DESCRIPTION

It should be noted that specific embodiments described herein are only used to explain the present disclosure but not intended to limit the present disclosure.

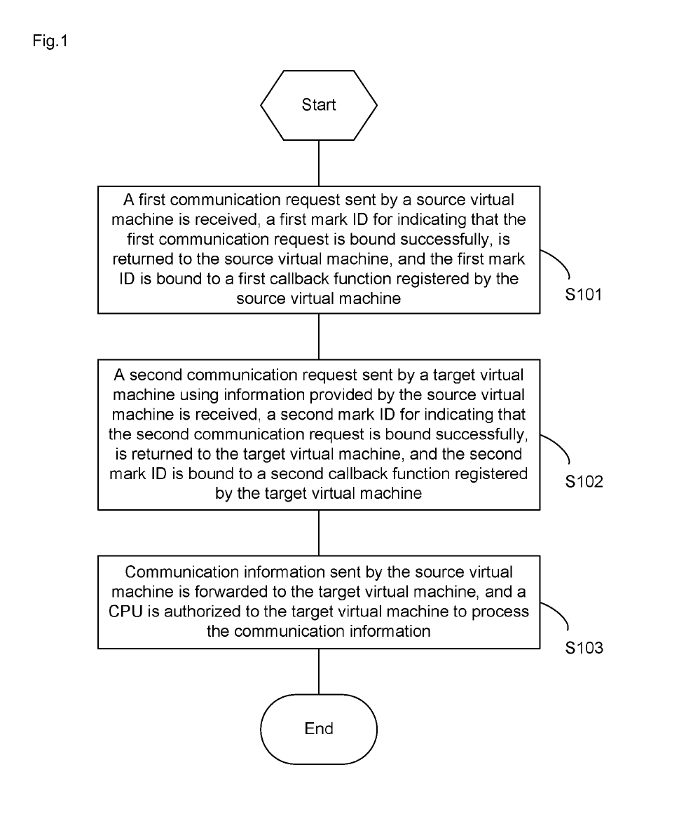

Referring to FIG. 1, provided is an embodiment of a method for implementing communications between virtual machines based on a scheduling layer according to the present disclosure, the method includes:

Step S101: A first communication request sent by a source virtual machine is received, a first mark ID for indicating that the first communication request is bound successfully, is returned to the source virtual machine, and the first mark ID is bound to a first callback function registered by the source virtual machine;

In the method for implementing communications between virtual machines based on a scheduling layer provided by the present disclosure, communication requests from the source virtual machine and one or more target virtual machines are received by the scheduling layer, and unique mark IDs are returned respectively, so that the source virtual machine and the target virtual machine are bound to their respectively received mark IDs. Then, the communication information sent by the source virtual machine is forwarded by the scheduling layer to the target virtual machine to be processed therein. Every time after receiving a communication request, the scheduling layer may process the request at once, and sent a scheduling instruction. In this way, the communication requests between the virtual machines can be responded and processed rapidly.

In the embodiment, if the source virtual machine needs to communicate with one or more target virtual machines on its opposite side, firstly, a first communication request needs to be sent to a scheduling layer, requesting to be bound to the scheduling layer.

After receiving the first communication request, the scheduling layer may return, a unique first mark ID for indicating that the first communication request sent by the source virtual machine is bound successfully to the scheduling layer, to the source virtual machine according to the request and after the successful binding. After receiving the unique first mark ID, the source virtual machine may store the first mark ID, register a first callback function, and bind the first mark ID to the first callback function, so that when communicating with the target virtual machine, the source virtual machine can implement corresponding callback, so as to achieve the objective of communicating with the target virtual machine.

Step S102: A second communication request sent by a target virtual machine using information provided by the source virtual machine is received, a second mark ID for indicating that the second communication request is bound successfully, is returned to the target virtual machine, and the second mark ID is bound to a second callback function registered by the target virtual machine;

After receiving the first mark ID from the scheduling layer and registering the first callback function, the source virtual machine needs to sent a notice including binding information of the source virtual machine to the target virtual machine on its opposite side. Then, the target virtual machine may use information carried in the notice, and send a binding request defined as a second communication request to the scheduling layer, requesting to be bound to the scheduling layer. After receiving the second communication request, the scheduling layer may check whether performing the binding according to information carried in the second communication request, if the binding is performed successfully, the scheduling layer may return, a unique second mark ID for indicating that the second communication request is successfully bound to the scheduling layer, to the target virtual machine. After receiving the unique second mark ID, the target virtual machine may store the second mark ID, register a second callback function, and bind the second mark ID to the second callback function, so that when communicating with the source virtual machine, the target virtual machine can implement corresponding callback, so as to achieve the objective of communicating with the source virtual machine.

In the embodiment, after receiving the first mark ID from the scheduling layer, registering the first callback function, and implementing the binding of the first mark ID to the first callback function, the source virtual machine needs to notify the target virtual machine desired to communicate with to request to be bound to the scheduling layer. In this way, the source virtual machine may provide the target virtual machine with information including a source virtual machine ID number and the first mark ID by sharing memory, so that the target virtual machine sends the second communication request according to the information. In the embodiment, the source virtual machine ID number is a unique ID number for indicating respective virtual machine, which is assigned to a source virtual machine and a target virtual machine when the scheduling layer performs initialization.

Step S103: Communication information sent by the source virtual machine is forwarded to the target virtual machine, and a CPU is authorized to the target virtual machine to process the communication information.

After the source virtual machine and the target virtual machine both implement successfully the binding to the scheduling layer, i.e., implementing a test process of communication requests from the source virtual machine and the target virtual machine, then the source virtual machine and the target virtual machine can communication with each other. Firstly, the source virtual machine may send communication information to the target virtual machine, and the scheduling layer may check at any time whether there is communication information sent by the source virtual machine to the target virtual machine, if there is, the scheduling layer may forward the communication information to the target virtual machine. Meanwhile, the scheduling layer may authorize a CPU to the target virtual machine to process the communication information. After receiving the communication information forwarded by the scheduling layer, the target virtual machine may call the second callback function bound to the second mark ID, so as to enter a target function, and process the communication information according to the corresponding function.

In the method for implementing communications between virtual machines based on a scheduling layer according to the present disclosure, communications between the source virtual machine and target virtual machine are implemented by the scheduling layer. Firstly, the first communication request and the second communication request sent respectively by the source virtual machine and the target virtual machine are received, and the first mark ID and the second mark ID for indicating successful bindings are returned, so that the source virtual machine and the target virtual machine are bound to their respectively received mark IDs. Then, the communication information sent by the source virtual machine is forwarded to the target virtual machine, and the CPU is authorized to the target virtual machine to process the communication information. By means of the method to implement communications between the source virtual machine and the target virtual machine, the source virtual machine in an upper layer can sent communication information to the target virtual machine directly through the scheduling layer, thus communication speed between virtual machines can be improved to a great extent and memory resources can be saved.

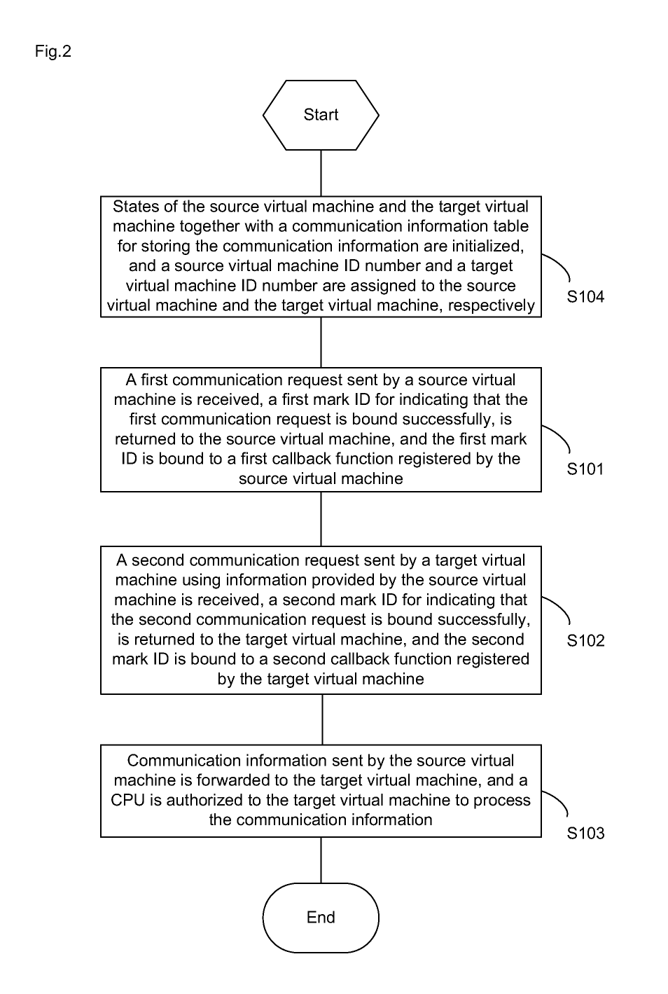

Referring to FIG. 2, provided is another embodiment of a method for implementing communications between virtual machines based on a scheduling layer according to the present disclosure. Before implementing step S101, the method further includes:

Step S104: States of the source virtual machine and the target virtual machine together with a communication information table for storing the communication information are initialized, and a source virtual machine ID number and a target virtual machine ID number are assigned to the source virtual machine and the target virtual machine, respectively.

In the embodiment, before communications between the source virtual machine and the target virtual machine are implemented by the scheduling layer, firstly, initialization needs to be performed by the scheduling layer, content of the initialization herein includes initializing states of the source virtual machine and the target virtual machine together with the communication information table, which is used to store the communication information after the scheduling layer receives communication requests from respective virtual machines. Whilst at the same time, ID numbers for indicating the source virtual machine and the target virtual machine need to be assigned respectively to the source virtual machine and the target virtual machine by the scheduling layer, and the two kinds of ID numbers may be defined respectively as a source virtual machine ID number and a target virtual machine ID number. Meanwhile, the source virtual machine and the target virtual machine need to be initialized in themselves, so as to register an interrupt function to facilitate establish communications with the scheduling layer.

Before communications between the source virtual machine and the target virtual machine are implemented, states of the source virtual machine and the target virtual machine together with the communication information table are initialized; whilst at the same time, the source virtual machine ID number and the target virtual machine ID number for indicating the source virtual machine and the target virtual machine are assigned respectively to the source virtual machine and the target virtual machine. Meanwhile, the source virtual machine and the target virtual machine need to be initialized in themselves. In this way, it is very convenient to receive communication requests from the source virtual machine and the target virtual machine by the scheduling layer, and to respond and process these communication requests rapidly. Accordingly, communication speed between virtual machines can be further ensured to a large extent.

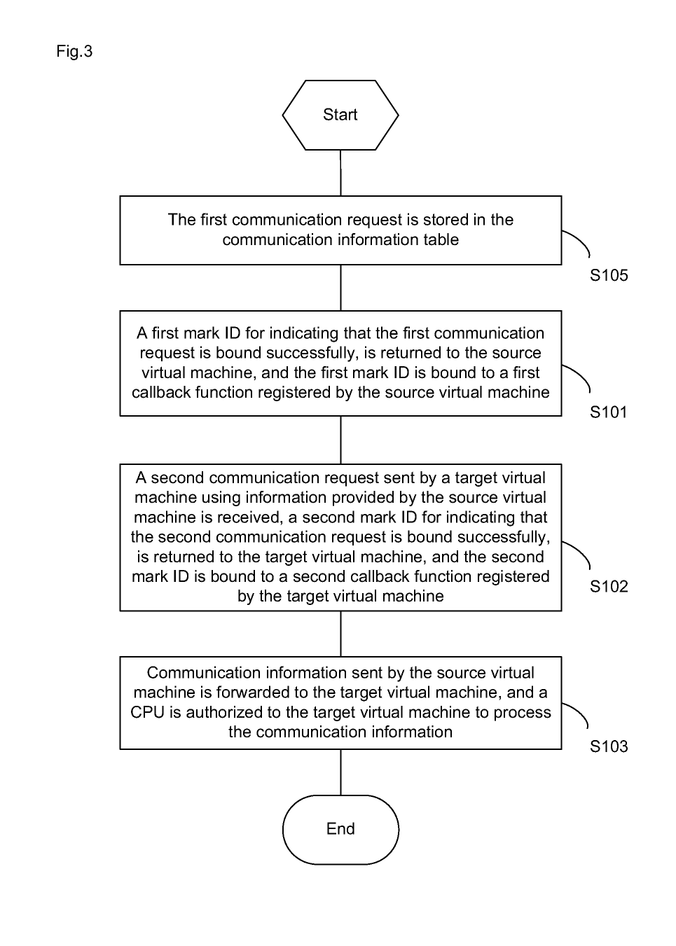

Referring to FIG. 3, provided is yet another embodiment of a method for implementing communications between virtual machines based on a scheduling layer according to the present disclosure. As shown in FIG. 3, the method may further include:

Step S105: The first communication request is stored in the communication information table.

In the embodiment, when the source virtual machine needs to communicate with one or more target virtual machines on its opposite side, firstly, a first communication request needs to be sent to the scheduling layer, requesting to be bound to the scheduling layer. After receiving the first communication request, the scheduling layer needs to store the first communication request, i.e., storing the first communication request in a communication information table in the scheduling layer, the communication information table provided herein is used to store the communication information after the scheduling layer receives the communication requests from respective virtual machines. After communications between the source virtual machine and the target virtual machine end, the scheduling layer may empty all the communication information stored in the communication information table, so as to store new communication information when communications between the source virtual machine and the target virtual machine are implemented next time.

The first communication request sent by the source virtual machine is stored in the communication information table of the scheduling layer, so as to store the communication information, which makes it convenient to check and test the communication information during communications between the source virtual machine and the target virtual machine.

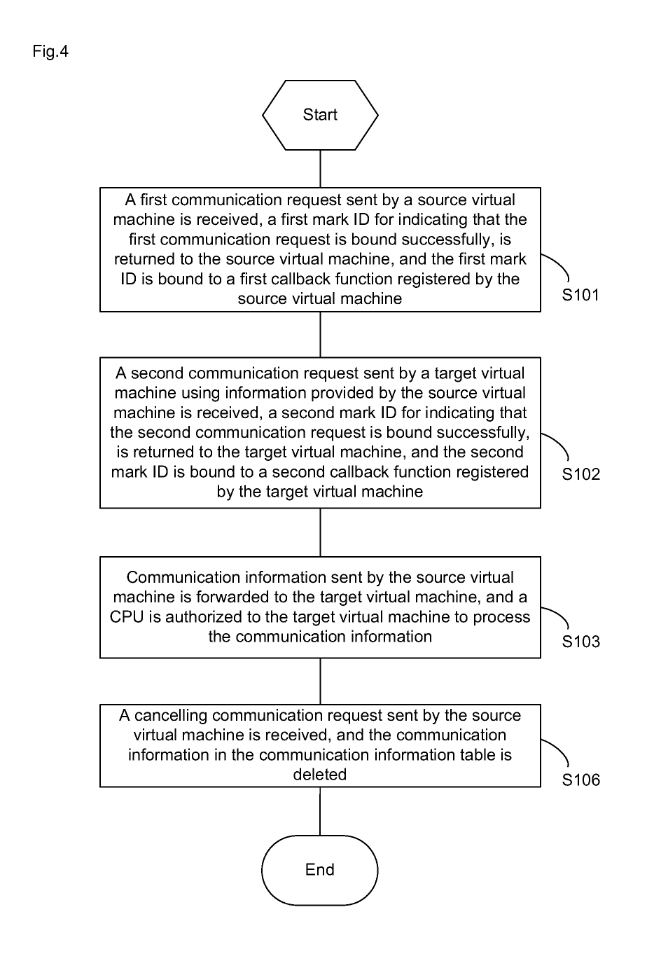

Referring to FIG. 4, provided is still another embodiment of a method for implementing communications between virtual machines based on a scheduling layer according to the present disclosure. After implementing step S103, the method may further include:

Step S106: A cancelling communication request sent by the source virtual machine is received, and the communication information in the communication information table is deleted.

In the embodiment, after communications between the source virtual machine and the target virtual machine are implemented by the scheduling layer, the scheduling layer needs to be notified by the source virtual machine to release binding information of the source virtual machine and all the target virtual machines, i.e., a cancelling communication request is sent by the source virtual machine to the scheduling layer, so as to request the scheduling layer to release the binding information of respective virtual machines. Meanwhile, after receiving the cancelling communication request sent by the source virtual machine, the scheduling layer further needs to delete the communication information, of the source virtual machine and all the target virtual machines which implement communications, stored in the communication information table. Furthermore, the source virtual machine and all the target virtual machines also need to simultaneously delete bindings between the first mark ID and the first callback function, and between the second mark ID and the second callbackk function.

After communications between the source virtual machine and all the target virtual machines are implemented by the scheduling layer, binding information of respective virtual machines are released, and the communication information, of the source virtual machine and all the target virtual machines which implement communications, stored in the communication information table, are deleted. In this way, it is further ensured that memory resources can be saved.

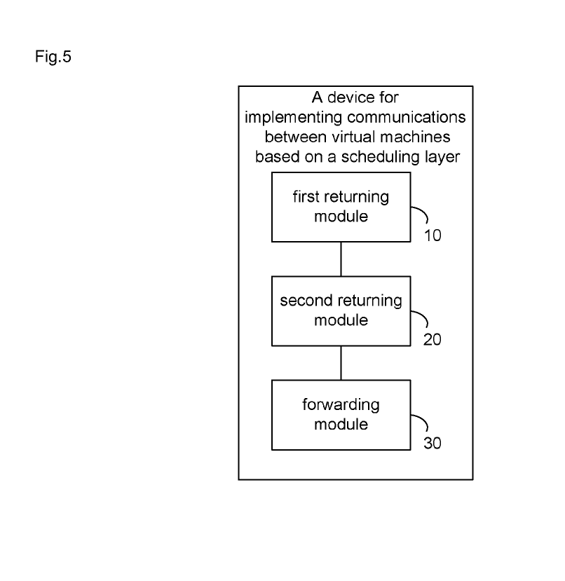

Referring to FIG. 5, provided is an embodiment of a device for implementing communications between virtual machines based on a scheduling layer according to the present disclosure. The device may include:

a first returning module 10, configured to receive a first communication request sent by a source virtual machine, return, a first mark ID for indicating that the first communication request is bound successfully, to the source virtual machine, and bind the first mark ID to a first callback function registered by the source virtual machine;

a second returning module 20, configured to receive a second communication request sent by a target virtual machine using information provided by the source virtual machine, return, a second mark ID for indicating that the second communication request is bound successfully, to the target virtual machine, and bind the second mark ID to a second callback function registered by the target virtual machine; and

a forwarding module 30, configured to forward communication information sent by the source virtual machine to the target virtual machine, and authorize a CPU to the target virtual machine to process the communication information.

In the device for implementing communications between virtual machines based on a scheduling layer provided by the present disclosure, communication requests from the source virtual machine and one or more target virtual machines are received by the scheduling layer, and unique mark IDs are returned respectively, so that the source virtual machine and the target virtual machine are bound to their respectively received mark IDs. Then, the communication information sent by the source virtual machine is forwarded by the scheduling layer to the target virtual machine to be processed therein. Every time after receiving a communication request, the scheduling layer may process the request at once, and sent a scheduling instruction. In this way, the communication requests between the virtual machines can be responded and processed rapidly.

In the embodiment, if the source virtual machine needs to communicate with one or more target virtual machines on its opposite side, firstly, a first communication request needs to be sent to a scheduling layer, requesting to be bound to the scheduling layer. After receiving the first communication request, the scheduling layer may return, by the first returning module 10, a unique first mark ID for indicating that the first communication request sent by the source virtual machine is bound successfully to the scheduling layer, to the source virtual machine according to the request and after the successful binding. After receiving the unique first mark ID, the source virtual machine may store the first mark ID, register a first callback function, and bind the first mark ID to the first callback function, so that when communicating with the target virtual machine, the source virtual machine can implement corresponding callback, so as to achieve the objective of communicating with the target virtual machine.

After receiving the first mark ID from the scheduling layer and registering the first callback function, the source virtual machine needs to sent a notice including binding information of the source virtual machine to the target virtual machine on its opposite side. Then, the target virtual machine may use information carried in the notice, and send a binding request defined as a second communication request to the scheduling layer, requesting to be bound to the scheduling layer. After receiving the second communication request, the scheduling layer may check whether performing the binding according to information carried in the second communication request, if the binding is performed successfully, the scheduling layer may return, by the second returning module 20, a unique second mark ID for indicating that the second communication request is successfully bound to the scheduling layer, to the target virtual machine. After receiving the unique second mark ID, the target virtual machine may store the second mark ID, register a second callback function, and bind the second mark ID to the second callback function, so that when communicating with the source virtual machine, the target virtual machine can implement corresponding callback, so as to achieve the objective of communicating with the source virtual machine.

In the embodiment, after receiving the first mark ID from the scheduling layer, registering the first callback function, and implementing the binding of the first mark ID to the first callback function, the source virtual machine needs to notify the target virtual machine desired to communicate with to request to be bound to the scheduling layer. In this way, the source virtual machine may provide the target virtual machine with information including a source virtual machine ID number and the first mark ID by sharing memory, so that the target virtual machine sends the second communication request according to the information. In the embodiment, the source virtual machine ID number and the target virtual machine ID number are unique ID numbers for indicating respective virtual machine, which are assigned to a source virtual machine and a target virtual machine when the scheduling layer performs initialization.

After the source virtual machine and the target virtual machine both implement successfully the binding to the scheduling layer, i.e., implementing a test process of communication requests from the source virtual machine and the target virtual machine, then the source virtual machine and the target virtual machine can communication with each other. Firstly, the source virtual machine may send communication information to the target virtual machine, and the scheduling layer may check at any time whether there is communication information sent by the source virtual machine to the target virtual machine, if there is, the forwarding module 30 may forward the communication information to the target virtual machine. Meanwhile, the scheduling layer may authorize a CPU to the target virtual machine to process the communication information. After receiving the communication information forwarded by the scheduling layer, the target virtual machine may call the second callback function bound to the second mark ID, so as to enter a target function, and process the communication information according to the corresponding function.

In the device for implementing communications between virtual machines based on a scheduling layer according to the present disclosure, communications between the source virtual machine and target virtual machine are implemented by the scheduling layer. Firstly, the first communication request and the second communication request sent respectively by the source virtual machine and the target virtual machine are received, and the first mark ID and the second mark ID for indicating successful bindings are returned, so that the source virtual machine and the target virtual machine are bound to their respectively received mark IDs. Then, the communication information sent by the source virtual machine is forwarded to the target virtual machine, and the CPU is authorized to the target virtual machine to process the communication information. By means of the aforementioned device to implement communications between the source virtual machine and the target virtual machine, the source virtual machine in an upper layer can sent communication information to the target virtual machine directly through the scheduling layer, thus communication speed between virtual machines can be improved to a great extent and memory resources can be saved.

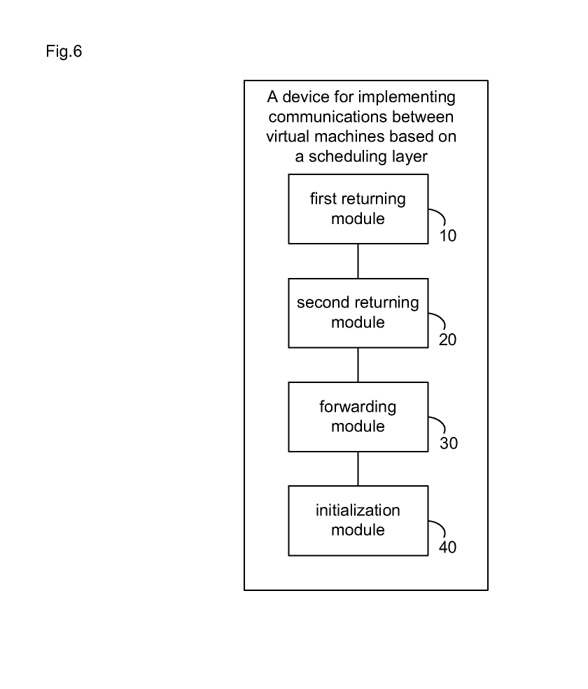

Referring to FIG. 6, provided is another embodiment of a device for implementing communications between virtual machines based on a scheduling layer according to the present disclosure. The device may further include:

an initialization module 40, configured to initialize states of the source virtual machine and the target virtual machine together with a communication information table for storing the communication information, and assign a source virtual machine ID number and a target virtual machine ID number to the source virtual machine and the target virtual machine, respectively.

In the embodiment, before communications between the source virtual machine and the target virtual machine are implemented by the scheduling layer, firstly, initialization needs to be performed by the initialization module 40, content of the initialization herein includes initializing states of the source virtual machine and the target virtual machine together with the communication information table, which is used to store the communication information after the scheduling layer receives communication requests from respective virtual machines. Whilst at the same time, ID numbers for indicating the source virtual machine and the target virtual machine need to be assigned respectively to the source virtual machine and the target virtual machine by the scheduling layer, and the two kinds of ID numbers may be defined respectively as a source virtual machine ID number and a target virtual machine ID number. Meanwhile, the source virtual machine and the target virtual machine need to be initialized in themselves, so as to register an interrupt function to facilitate establish communications with the scheduling layer.

Before communications between the source virtual machine and the target virtual machine are implemented, states of the source virtual machine and the target virtual machine together with the communication information table are initialized; whilst at the same time, the source virtual machine ID number and the target virtual machine ID number for indicating the source virtual machine and the target virtual machine are assigned respectively to the source virtual machine and the target virtual machine. Meanwhile, the source virtual machine and the target virtual machine need to be initialized in themselves. In this way, it is very convenient to receive communication requests from the source virtual machine and the target virtual machine by the scheduling layer, and to respond and process these communication requests rapidly. Accordingly, communication speed between virtual machines can be further ensured to a large extent.

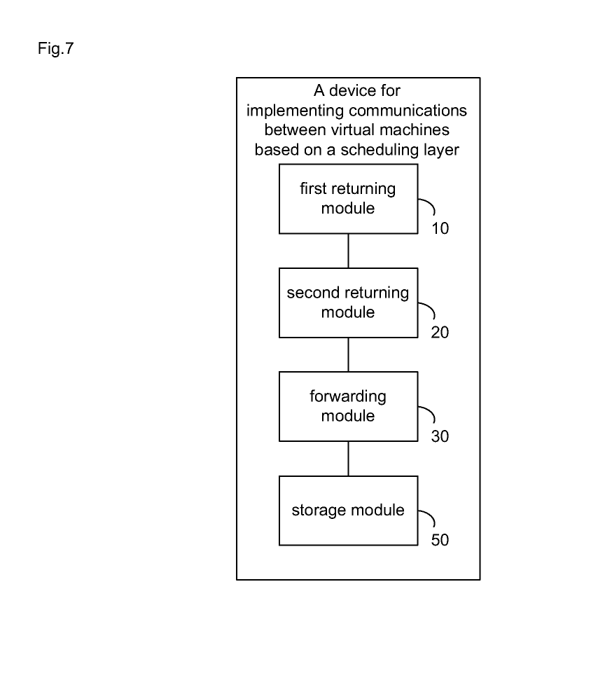

Referring to FIG. 7, provided is yet another embodiment of a device for implementing communications between virtual machines based on a scheduling layer according to the present disclosure. The device may further include:

a storage module 50, configured to store the first communication request in the communication information table.

In the embodiment, when the source virtual machine needs to communicate with one or more target virtual machines on its opposite side, firstly, a first communication request needs to be sent to the scheduling layer, requesting to be bound to the scheduling layer. After the scheduling layer receives the first communication request, the storage module 50 needs to store the first communication request, i.e., storing the first communication request in a communication information table in the scheduling layer, the communication information table provided herein is used to store the communication information after the scheduling layer receives the communication requests from respective virtual machines. After communications between the source virtual machine and the target virtual machine end, the scheduling layer may empty all the communication information stored in the communication information table, so as to store new communication information when communications between the source virtual machine and the target virtual machine are implemented next time.

The first communication request sent by the source virtual machine is stored in the communication information table of the scheduling layer, so as to store the communication information, which makes it convenient to check and test the communication information during communications between the source virtual machine and the target virtual machine.

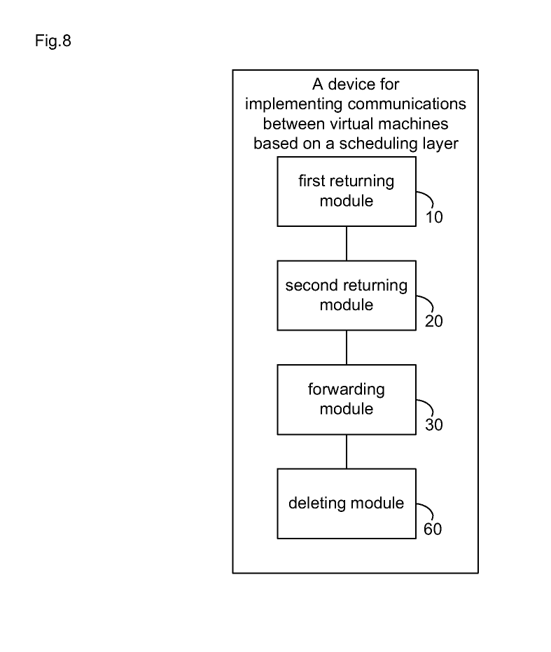

Referring to FIG. 8, provided is still another embodiment of a device for implementing communications between virtual machines based on a scheduling layer according to the present disclosure. The device may further include:

a deleting module 60, configured to receive a cancelling communication request sent by the source virtual machine, and delete the communication information in the communication information table.

In the embodiment, after communications between the source virtual machine and the target virtual machine are implemented by the scheduling layer, the scheduling layer needs to be notified by the source virtual machine to release binding information of the source virtual machine and all the target virtual machines, i.e., a cancelling communication request is sent by the source virtual machine to the scheduling layer, so as to request the scheduling layer to release the binding information of respective virtual machines. Meanwhile, after the scheduling layer receives the cancelling communication request sent by the source virtual machine, the deleting module 60 further needs to delete the communication information, of the source virtual machine and all the target virtual machines which implement communications, stored in the communication information table. Furthermore, the source virtual machine and all the target virtual machines also need to simultaneously delete bindings between the first mark ID and the first callback function, and between the second mark ID and the second callbackk function.

After communications between the source virtual machine and all the target virtual machines are implemented by the scheduling layer, binding information of respective virtual machines are released, and the communication information, of the source virtual machine and all the target virtual machines which implement communications, stored in the communication information table, are deleted. In this way, it is further ensured that memory resources can be saved.

What described are merely preferable embodiments of the present disclosure, and are not intended to limit the scope of the present disclosure. All equivalent structures or equivalent flow variations made using content of the specification and accompanying drawings of the present disclosure, or direct or indirect application to another related technical field, likewise fall within the scope of the present disclosure.

1. A method for implementing communications between virtual machines based on a scheduling layer, comprising:
receiving a first communication request sent by a source virtual machine, returning, a first mark ID for indicating that the first communication request is bound successfully, to the source virtual machine, and binding the first mark ID to a first callback function registered by the source virtual machine;
receiving a second communication request sent by a target virtual machine using information provided by the source virtual machine, returning, a second mark ID for indicating that the second communication request is bound successfully, to the target virtual machine, and binding the second mark ID to a second callback function registered by the target virtual machine; and
forwarding communication information sent by the source virtual machine to the target virtual machine, and authorizing a CPU to the target virtual machine to process the communication information.

2. The method according to claim 1, wherein before the step of receiving a first communication request sent by a source virtual machine, and returning, a first mark ID for indicating that the first communication request is bound successfully, the method further comprises:
initializing states of the source virtual machine and the target virtual machine together with a communication information table for storing the communication information, and assigning a source virtual machine ID number and a target virtual machine ID number to the source virtual machine and the target virtual machine, respectively.

3. The method according to claim 2, wherein the target virtual machine using information provided by the source virtual machine, comprises:
the target virtual machine using the source virtual machine ID number and the first mark ID provided by the source virtual machine.

4. The method according to claim 2, wherein before the step of returning, a first mark ID for indicating that the first communication request is bound successfully, to the source virtual machine, the method further comprises:
storing the first communication request in the communication information table.

5. The method according to claim 2, wherein after the step of forwarding communication information sent by the source virtual machine to the target virtual machine, and authorizing a CPU to the target virtual machine to process the communication information, the method further comprises:
receiving a cancelling communication request sent by the source virtual machine, and deleting the communication information in the communication information table.

6. A device for implementing communications between virtual machines based on a scheduling layer, comprising:
a first returning module, configured to receive a first communication request sent by a source virtual machine, return, a first mark ID for indicating that the first communication request is bound successfully, to the source virtual machine, and bind the first mark ID to a first callback function registered by the source virtual machine;
a second returning module, configured to receive a second communication request sent by a target virtual machine using information provided by the source virtual machine, return, a second mark ID for indicating that the second communication request is bound successfully, to the target virtual machine, and bind the second mark ID to a second callback function registered by the target virtual machine; and
a forwarding module, configured to forward communication information sent by the source virtual machine to the target virtual machine, and authorize a CPU to the target virtual machine to process the communication information.

7. The device according to claim 6, further comprising:
an initialization module, configured to initialize states of the source virtual machine and the target virtual machine together with a communication information table for storing the communication information, and assign a source virtual machine ID number and a target virtual machine ID number to the source virtual machine and the target virtual machine, respectively.

8. The device according to claim 7, wherein the target virtual machine using information provided by the source virtual machine, comprises: the source virtual machine ID number and the first mark ID.

9. The device according to claim 7, further comprising:
a storage module, configured to store the first communication request in the communication information table.

10. The device according to claim 7, further comprising:
a deleting module, configured to receive a cancelling communication request sent by the source virtual machine, and delete the communication information in the communication information table.

11. The method according to claim 3, wherein after the step of forwarding communication information sent by the source virtual machine to the target virtual machine, and authorizing a CPU to the target virtual machine to process the communication information, the method further comprises:
receiving a cancelling communication request sent by the source virtual machine, and deleting the communication information in the communication information table.

12. The method according to claim 4, wherein after the step of forwarding communication information sent by the source virtual machine to the target virtual machine, and authorizing a CPU to the target virtual machine to process the communication information, the method further comprises:
receiving a cancelling communication request sent by the source virtual machine, and deleting the communication information in the communication information table.

13. The device according to claim 8, further comprising:
a deleting module, configured to receive a cancelling communication request sent by the source virtual machine, and delete the communication information in the communication information table.

14. The device according to claim 9, further comprising:
a deleting module, configured to receive a cancelling communication request sent by the source virtual machine, and delete the communication information in the communication information table.
